(19) United States
(12) Patent Application Publication
(10) Pub. No.: US 2007/0022610 A1
(43) Pub. Date: Feb. 1, 2007

(54) Plastic tube cutter

(76) Inventor: Chi-Chieh Huang, Feng Yuan City (TW)

Correspondence Address: CHARLES E. BAXLEY, ESQ., 90 JOHN STREET, THIRD FLOOR, NEW YORK, NY, 10038, US

(21) Appl. No.: 11/190,522

(22) Filed: Jul. 28, 2005

(51) Int. Cl. B26D 3/16

(52) U.S. Cl. 30/92

(57) ABSTRACT

A plastic tube cutter comprises a housing, a blade holder and a blade, the blade is fixed to the connecting portion of the blade holder and is clamped between the clamping block and the locking piece. And then the blade, the clamping block and the locking piece are fastened together by screwing fasteners through the holes of the blade holder and the clamping block and into the threaded holes of the locking pieces. By pressing the lever, the blade holder will be moved to a predetermined position at which the fasteners are aligned to the through holes of the housing, so that the blade is reassembled easily by unscrewing the fasteners through the through holes, without dismantling the housing.

### BACKGROUND OF THE INVENTION

1. Field of the Invention

The present invention relates to a cutter, and more particularly to a plastic tube cutter.

2. Description of the Prior Art

A conventional tube cutter generally comprises a housing, a blade holder and a blade assembly consisted of a pair of blades. After the blade assembly is fixed to the blade holder, then it is disposed in the housing. During use, the blade assembly can extend out of the housing gradually for cutting tube.

After a certain time of use, the blades of the tube cutter will become blunt and need to be replaced. However, the blade assembly of the tube cutter is hidden in the housing, so that the housing must be disassembled and assembled before and after the blade assembly is replaced, plus many small components, such as springs, are arranged in the housing and also need to take care. Therefore, replacing the blade is really troublesome and time-consuming.

The present invention has arisen to mitigate and/or obviate the afore-described disadvantages.

### SUMMARY OF THE INVENTION

The primary objective of the present invention is to provide a plastic tube cutter, wherein the blade is fixed to the connecting portion of the blade holder and is clamped between the clamping block and the locking piece. And then the blade, the clamping block and the locking piece are fastened together by screwing fasteners through the holes of the blade holder and the clamping block and into the threaded holes of the locking pieces, by pressing the lever, the blade holder will be moved to a predetermined position at which the fasteners are aligned to the through holes of the housing, so that the blade is reassembled easily by unscrewing the fasteners through the through holes, without dismantling the housing.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a plastic tube cutter in accordance with the present invention;

FIG. 2 is a cross sectional view of the plastic tube cutter in accordance with the present invention;

FIG. 3 is an exploded view of showing the blade holder and the blade in accordance with the present invention;

FIG. 4 is another exploded view of showing the blade holder and the blade in accordance with the present invention.

### DETAILED DESCRIPTION OF THE PREFERRED EMBODIMENT

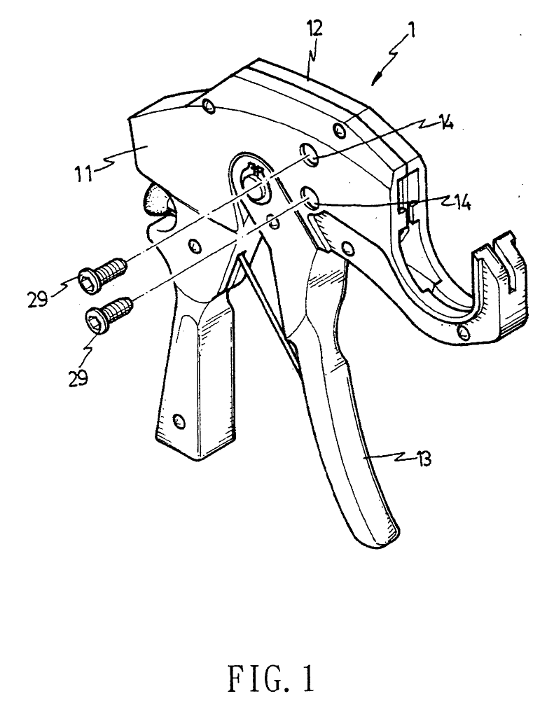

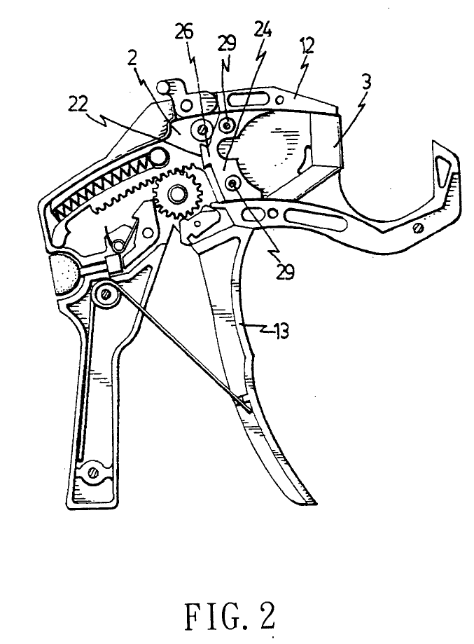

Referring to FIGS. 1 and 2, a plastic tube cutter in accordance with the present invention is shown and comprises a housing 1, a blade holder 2 and a blade 3. The housing 1 includes two half shells 11 and 12 attached to each other, and to the lower end of the housing 1 is fixed a lever 13 to be pressed by the finger of a user. The blade holder 2 is integral with the blade 3 and is disposed in the housing 1. The blade 3 will move out of the housing gradually by pressing the lever 13.

The improvement of the present invention is that the half shell 11 of the housing 1 is formed with a plurality of through holes 14 (can also be elongated holes) that are located correspondingly to the travel path of the blade holder 2.

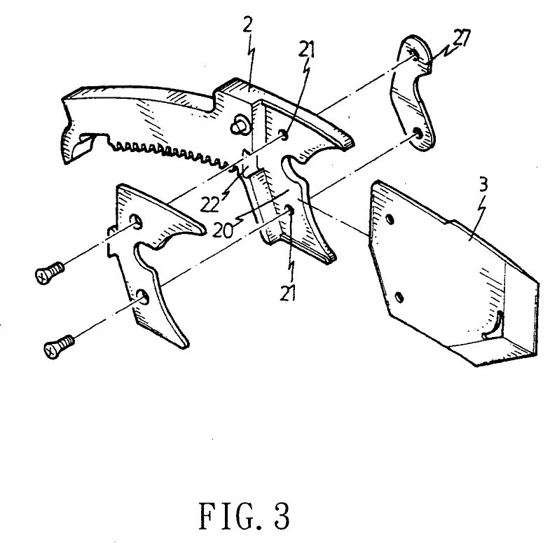

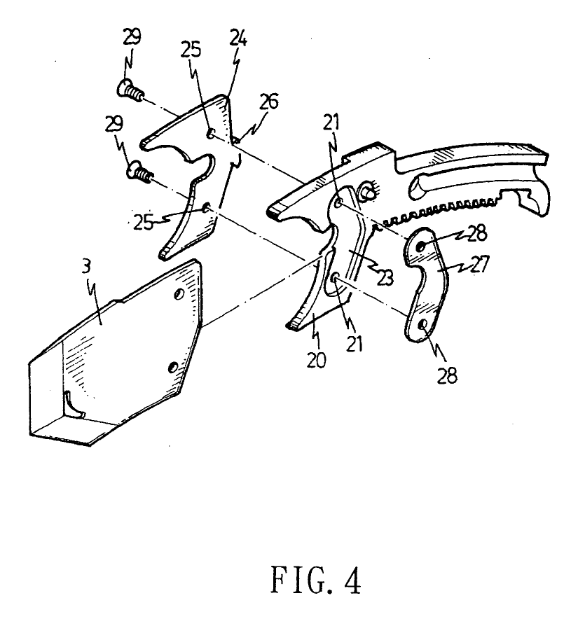

Referring further to FIGS. 2-4, at an end of the blade holder 2 is formed a connecting portion 20 on which being defined a plurality of through holes 21. Adjacent to an edge of a side surface the connecting portion 20 is formed a dovetail locking notch 22, and at another side surface of the blade holder 2 is defined a recess 23.

A clamping block 24 having a shape corresponding to the shape of the connecting portion 20 is formed with a plurality of holes 25. At a lateral edge of the clamping block 24 is formed a dovetail locking protrusion 26 that is to be engaged in the locking notch 22, and the holes 25 of the clamping block 24 will be aligned to the holes 21 of the connecting portion 20 automatically once the clamping block 24 is positioned.

A locking piece 27 has a shape corresponding to the shape of the recess 23 and is defined at both ends thereof with a threaded hole 28, and the threaded holes 28 will be aligned to the holes 21 after the locking piece 27 is fixed to the connecting portion 20.

The blade 3 is fixed to the connecting portion 20 of the blade holder 2 in such a manner that the clamping block 24 and the locking piece 27 are installed in the locking notch 22 and the recess 23, respectively, to clamp the blade 3, and then the blade 3, the clamping block 24 and the locking piece 27 are fastened together by screwing fasteners 29 through the holes 21, 25 into the threaded holes 28.

Referring back to FIGS. 1 and 2, blade replacement can be easily done by the following steps: by pressing the lever 13, the blade holder 2 will be moved to a predetermined position at which the fasteners 29 for securing the clamping block 24, the locking piece 27, the blade 3 and the blade holder 2 are aligned to the through holes 14, and an end of the blade 3 protrudes slightly out of the housing 1. And then the fasteners 29 can be unscrewed by using a tool, such as a hexagonal screwdriver, via the through holes 14. After the fasteners 29 is unscrewed from the blade 3, the blade 3 can be reassembled and a new blade 3 can be assembled and fixed to the blade holder 2 by screwing the fasteners 29 back into their original positions.

Unlike the conventional tube cutter, the blade of the tube cutter in accordance with the present invention can be replaced easily without removing the housing 1. Furthermore, all the components of the tube cutter are still kept in their respective positions without leaving the housing 1 throughout the blade replacement process.

While we have shown and described various embodiments in accordance with the present invention, it should be clear to those skilled in the art that further embodiments may be made without departing from the scope of the present invention.

What is claimed is:

1. A plastic tube cutter comprising:
a housing, a blade holder and a blade, the housing including two half shells attached to each other, and to a lower end of the housing is fixed a lever to be pressed by the user, the blade holder being integral with the blade and disposed in the housing, the blade will move out of the housing gradually by pressing the lever;
one of the half shells of the housing is formed with a plurality of through holes that are located correspondingly to a travel path of the blade holder;
at an end of the blade holder is formed a connecting portion on which being defined a plurality of through holes, adjacent to an edge of a side surface the connecting portion is formed a locking notch, and at another side surface of the blade holder is defined a recess;
a clamping block is formed with a plurality of holes, at a lateral edge of the clamping block is formed a locking protrusion that is to be engaged in the locking notch of the blade holder, and the holes of the clamping block will be aligned to the holes of the connecting portion once the clamping block is positioned; and
a locking piece defined at both ends thereof with a threaded hole, and the threaded holes will be aligned to the holes of the connecting portion after the locking piece is fixed to the connecting portion;
the blade is fixed to the connecting portion of the blade holder and is clamped between the clamping block and the locking piece, and then the blade, the clamping block and the locking piece are fastened together by screwing fasteners through the holes of the blade holder and the clamping block and into the threaded holes of the locking pieces, by pressing the lever, the blade holder will be moved to a predetermined position at which the fasteners are aligned to the through holes of the housing, so that the blade is reassembled easily by unscrewing the fasteners through the through holes, without dismantling the housing.

2. The plastic tube cutter as claimed in claim 1, wherein the locking notch is of a dovetail shape, and the locking protrusion is also dovetail-shaped for mating with the locking notch.
